(19) United States
(12) Patent Application Publication
(10) Pub. No.: US 2008/0109514 A1
(43) Pub. Date: May 8, 2008

(54) METHOD OF INITIATING A CONNECTION WITH AN INDIVIDUAL

(76) Inventor: Tim Baudler, Hollywood, CA (US)

Correspondence Address: ZARLEY LAW FIRM P.L.C., CAPITAL SQUARE, 400 LOCUST, SUITE 200, DES MOINES, IA, 50309-2350, US

(21) Appl. No.: 11/556,364

(22) Filed: Nov. 3, 2006

(51) Int. Cl. G06F 15/16

(52) U.S. Cl. 709/204

(57) ABSTRACT

A method of initiating a connection with an individual on a wide area network. The method includes determining a personal identifier associated with an individual, accessing a personal profile of the individual by inputting the personal identifier into a remote terminal and initiating a connection with the individual based upon the personal profile.

### BACKGROUND OF THE INVENTION

This invention relates to Internet dating. With the invention of the Internet a new way of dating individuals has become popular. Specifically there are a plurality of dating websites that are used by singles in order to match them with an individual for dating purposes. These websites use many different techniques in order to cause individuals to meet with one another. These techniques include filling out long identification profiles, personal statements and the like. Additionally, most of these websites allow an individual to place a picture of themselves onto the website. Oftentimes the profile information and the pictures on the website are inaccurate and build unreasonable expectations for individuals during a first date. Thus this leads to many unsuccessful first dates and unhappy individuals.

Therefore it is a principal object of the present invention to provide an online dating service and improves the accuracy of individuals expectations of one another.

Yet another object of the present invention is to provide an online dating service that allows individuals to use a personal identifier in order to meet individuals.

These and other objects, features, or advantages of the present invention will become apparent from the specification and claims.

### BRIEF SUMMARY OF THE INVENTION

A method of initiating a connection with an individual on a wide area network. The method includes determining a personal identifier associated with an individual and then accessing a personal profile of the individual by inputting the personal identifier into a remote terminal. After accessing the personal profile, an individual may decide to initiate a connection with the individual.

### BRIEF DESCRIPTION OF THE DRAWINGS

FIG. 1 is a schematic diagram of a web server using connection with remote terminals; and

FIG. 2 is a diagram of a method of initiating connection with an individual.

### DETAILED DESCRIPTION OF THE PREFERRED EMBODIMENT OF THE INVENTION

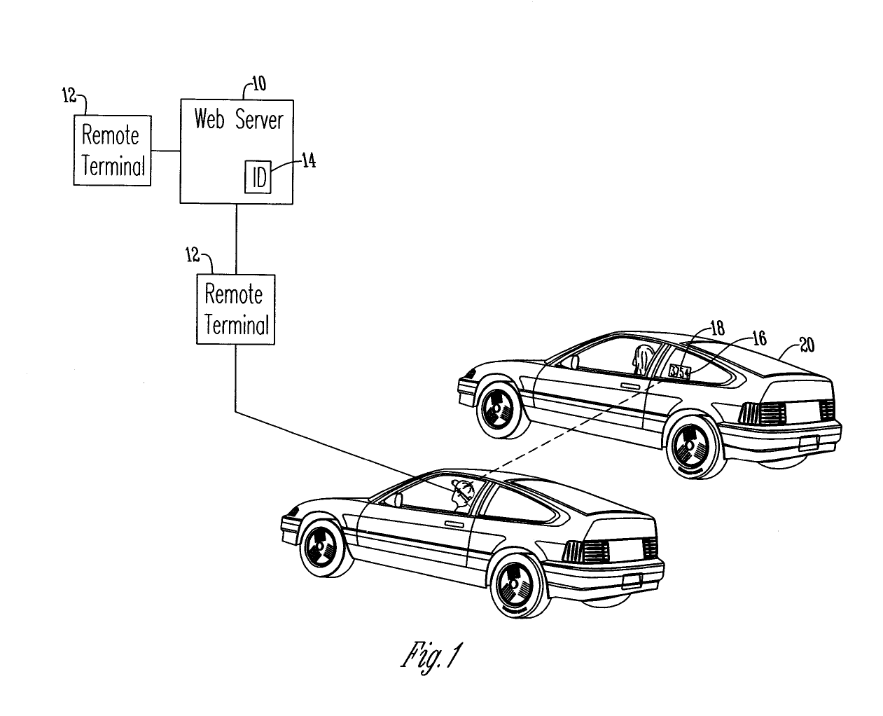

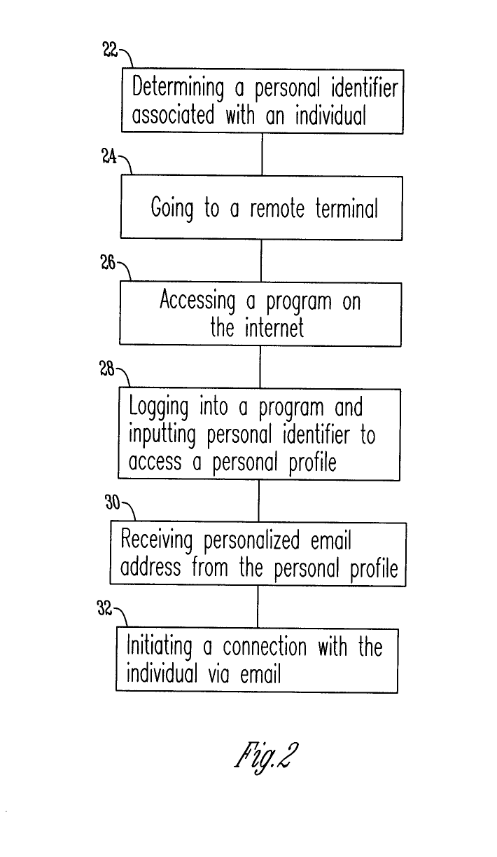

In referring to FIGS. 1 and 2 the figures show an improved method of initiating a connection with an individual using the Internet. Specifically the method uses a web server 10 that communicates with remote terminals 12. The web server 10 has a program 14 therein that can be in the form of a website that stores personal profiles of individuals that may be accessed from the remote terminals 12. Specifically the website 14 may only be accessed by exclusive members that have a log in and password to allow access to the website. Each individual that has access to the website is able to input a personal profile providing personal information about themselves that they would want another individual to know. This includes interests, hobbies, and the like.

Once logged onto the website 14 an individual may access other individual's personal profiles by using a personal identifier that is associated with each individual on the website 14. Specifically in a preferred embodiment the personal identifier is a number that is associated with a users profile such that when the number is inputted into the remote terminal 12 the profile of the user can then be accessed. At this time the accessed profile provides an anonymous e-mail address such that if an individual that has accessed the personal profile is interested in contacting the individual having the profile, the user may e-mail the individual and attempt to communicate with them and possibly set up a date.

An individual may provide others with their personal identification number in any manner. For example, an individual may place their personal identification on a sticker 16 that can be placed in the window 18 of their automobile 20 or perhaps on an article of clothing or jewelry such as a bracelet. The sticker 16 can be removable. This includes the sticker being a decal that can be placed on a window 18 as shown in FIG. 1 or as a magnet that may be placed on the door of the automobile 20.

Thus, while driving down a street a first member of the website upon seeing an individual in passing that they find attractive having a sticker 16, the first individual can remember the number on the sticker 16 and access the personal profile of the second member using the personal identification number. Similarly when in a social setting such as a bar or dance club when meeting a person that someone has a connection with instead of the individual providing their phone number they can provide their personal identification number so they may be contacted over the Internet.

The steps of the method of initiating connection are best shown in FIG. 2. The first step 22 is determining a personal identifier associated with an individual as is discussed above. Upon receiving the personal identifier, a member goes to a remote terminal as shown in step 24. At the remote terminal the individual accesses the program 14, or website on the internet as shown in step 26. At step 28 the user logs onto the website and inputs the personal identifier to access the personal profile of the individual. Then if the user is still interested they can receive the personalized email address of the individual at step 30. The personalized email address is presented so an individual cannot have access to a persons real email address for safety and fraud purposes. Upon receiving the email address the user may initiate a connection with the individual via by emailing the individual at step 32.

Thus, by using a personal identifier a user may meet an individual or at least see the individual in passing before initiating a connection with the individual. Therefore, expectations regarding an individual are minimized as are inaccuracies regarding the person and their appearance. Additionally because of safeguards, the website allows for anonymous e-mailing and insures that you are attracted to the individual that you contact. Consequently at the very least, all the stated objectives have been met.

It will be appreciated by those skilled in the art that other various modifications could be made to the device without the parting from the spirit in scope of this invention. All such modifications and changes fall within the scope of the claims and are intended to be covered thereby.

What is claimed is:

1. A method of initiating connection with an individual on a wide area network comprising steps of:
determining a personal identifier associated with an individual;
accessing a personal profile of the individual by inputting the personal identifier into a remote terminal; and
initiating a connection with the individual after viewing the personal profile.

2. The method of claim 1 wherein the personal identifier is a personal identification number.

3. The method of claim 1 wherein the personal identifier is on a sticker placed on an automobile having a personal identification number.

4. The method of claim 1 wherein the remote terminal is a computer.

5. The method of claim 1 wherein the remote terminal communicates with a web server to access the personal profile.

6. The method of claim 5 wherein a user must log into a website on the web server to access the personal profile.

7. The method of claim 1 wherein the connection with the individual is made via e-mail.
